(19) United States
(12) Patent Application Publication
(10) Pub. No.: US 2014/0355872 A1
(43) Pub. Date: Dec. 4, 2014

(54) METHOD FOR DETERMINING INTERPOLATING DIRECTION FOR COLOR DEMOSAICKING

(71) Applicant: Himax Imaging Limited, Tainan City (TW)

(72) Inventor: Yen-Te Shih, Tainan City (TW)

(73) Assignee: Himax Imaging Limited, Tainan City (TW)

(21) Appl. No.: 13/903,579

(22) Filed: May 28, 2013

(51) Int. Cl. G06T 7/40; G06T 7/00

(52) U.S. Cl. CPC G06T 7/408; G06T 7/0085
USPC 382/164

(57) ABSTRACT

The invention provides a method for determining interpolating direction for color demosaicking. In the method, edge information of each pixel of an image captured by a color filter array is first obtained. Then, a highly horizontal level and a highly vertical level of each pixel are determined. An interpolating direction of each pixel is determined based on the edge information, the highly horizontal level and the highly vertical level of the pixel.

### BACKGROUND OF THE INVENTION

1. Field of the Invention

The invention relates to digital image processing, and more particularly to determining interpolating direction for color demosaicking.

2. Description of the Related Art

Most digital cameras or image sensors use a color filter array, such as the well-known Bayer color filter array, to capture a digital image in order to reduce costs. In this way, each pixel in the captured image has only one measured color. This kind of image is called a mosaic image. FIG. 1 illustrates a structure of a Bayer pattern, wherein G is green, R is red, and B is blue. To reconstruct a full color image, a process called color demosaicking is implemented.

Color demosaicking is a process to estimate information of missing two colors for each pixel. For example, some color demosaicking methods use bilinear interpolation to estimate information of missing two colors for each pixel. In bilinear interpolation, unknown information of the two colors is calculated based on an average of values of neighboring pixels in a vertical, horizontal and/or diagonal direction. However, artifacts, such as zipper effect or false color, might occur in the demosaicked image after color demosaicking, reducing image quality. The zipper effect makes a straight edge in the image look like a zipper. Effects on a part of the artifacts can be diminished by preventing interpolation across edges. Therefore, determining interpolating direction for color demosaicking is an important issue.

### BRIEF SUMMARY OF THE INVENTION

In view of the above, the invention provides a method for determining interpolating direction for color demosaicking. In one embodiment, steps of the method comprise: obtaining edge information of each pixel of an image captured by a color filter array; determining a highly horizontal level and a highly vertical level of each pixel; and determining an interpolating direction of each pixel based on the edge information, the highly horizontal level and the highly vertical level of the pixel.

In another embodiment, the invention provides a non-transitory machine-readable storage medium, having an encoded program code, wherein when the program code is loaded into and executed by a machine, the machine implements a method for determining interpolating direction for color demosaicking, and the method comprises: obtaining edge information of each pixel of an image captured by a color filter array; determining a highly horizontal level and a highly vertical level of each pixel; and determining an interpolating direction of each pixel based on the edge information, the highly horizontal level and the highly vertical level of the pixel.

In still another embodiment, the invention provides an apparatus for determining interpolating direction for color demosaicking, comprising: an input module, receiving an image captured by a color filter array; an edge sensing module coupled to the input module, obtaining edge information of each pixel of the image; a direction level evaluating module coupled to the input module, determining a highly horizontal level and a highly vertical level of each pixel; a direction determining module coupled to the edge sensing module and the direction level evaluating module, determining an interpolating direction of each pixel based on the edge information, the highly horizontal level and the highly vertical level of the pixel; and an output module coupled to the direction determining module, outputting the interpolating direction of each pixel

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates a structure of a Bayer pattern;

FIG. 2 illustrates a flow chart of a method for determining interpolating direction for color demosaicking in accordance with an embodiment of the invention;

FIG. 3 illustrates an example of computing a vertical edge variation;

FIG. 4 illustrates an example of computing a first diagonal edge variation;

FIG. 5 illustrates an example of computing a highly vertical level;

FIG. 6 illustrates an example of computing a highly horizontal level;

FIG. 7 illustrates a flow chart of determining an interpolating direction of each pixel in accordance with an embodiment of the invention;

FIG. 8a and FIG. 8b illustrate examples of checking the consistency of the interpolating directions;

FIG. 9 illustrates a block diagram of an apparatus for determining interpolating direction for color demosaicking in accordance with an embodiment of the invention.

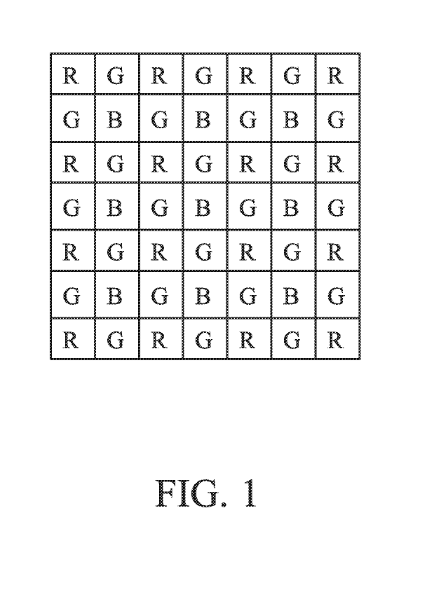

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

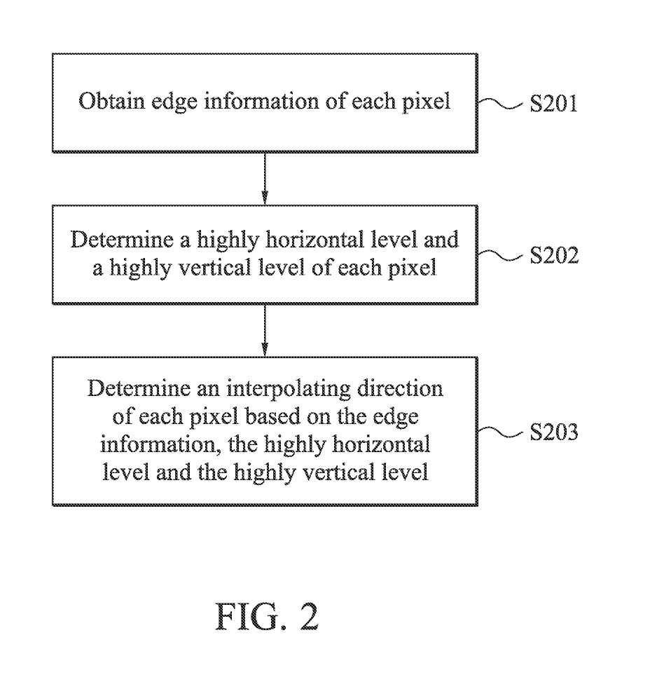

FIG. 2 illustrates a flow chart of a method for determining interpolating direction for color demosaicking in accordance with an embodiment of the invention.

In step S201, edge information of each pixel captured by a color filter array is obtained. In one example, the edge information includes a vertical edge variation, a horizontal edge variation, a first diagonal edge variation and a second diagonal edge variation. In an image, there are edges where the light intensity (luminance) changes sharply, such as a boundary of an object in the image. The edge information herein is to estimate whether a pixel lies on an edge, and if so, to determine the direction of the edge. The vertical edge variation represents a vertical luminance gradient of a pixel. The horizontal edge variation represents a horizontal luminance gradient of a pixel. The first diagonal edge variation represents a northeast-southwest luminance gradient of a pixel. The second diagonal edge variation represents a northwest-southeast luminance gradient of the pixel. The vertical edge variation, the horizontal edge variation, the first diagonal edge variation and the second diagonal edge variation will be described in detail later. To be noted, in the specification, vertical is equal to north-south and horizontal is equal to east-west.

In step S202, a highly horizontal level and a highly vertical level of each pixel are determined. The highly horizontal level represents the possibility that the pixel is in a region where luminance values of pixels fluctuate in a vertical direction. The highly vertical level represents the possibility that the pixel is in a region where luminance of pixels fluctuate in a horizontal direction. If a highly horizontal level of a pixel is large, it is much more possible that the pixel is in a region with horizontal stripes. On the other hand, if a highly vertical level of a pixel is large, it is much more possible that the pixel is in a region with vertical stripes. The highly horizontal level and the highly vertical level will be described in detail later.

In step S203, an interpolating direction of each pixel is determined based on the edge information, the highly horizontal level and the highly vertical level. The detail of determining the interpolating direction based on the edge information, the highly horizontal level and the highly vertical level will be described later.

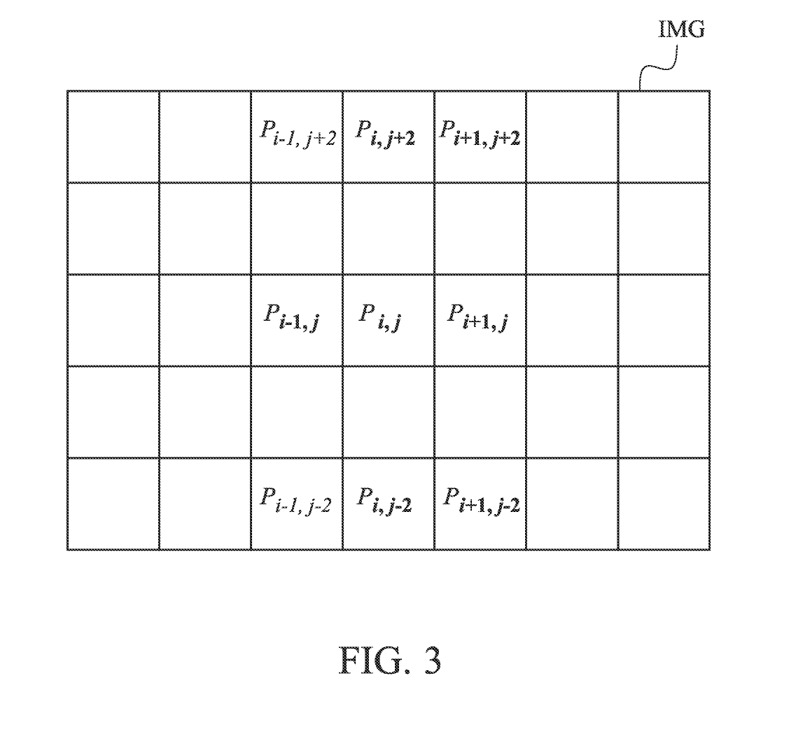

FIG. 3 illustrates an example of computing a vertical edge variation. An image IMG is captured by a Bayer color filter. The vertical edge variation V of a pixel P_{i,j} at (i,j) is obtained from the following formula:

$$V = {\sum }_{n = - a}^{+ a} \vert L ( {P}_{i + n , j + 2} ) - L ( {P}_{i + n , j} ) \vert + {\sum }_{n = - a}^{+ a} \vert L ( {P}_{i + n , j - 2} ) - L ( {P}_{i + n , j} ) \vert ,$$

wherein a is a user-defined positive integer and L(P_{x, y}) is luminance of a pixel P_{x, y} at (x, y).

Based on the formula described above, take a=1 as an example, as shown in FIG. 3, the vertical edge variation V of a pixel P_{i,j} at (i,j) is:

V=|L(P_{i-1,j+2})−L(P_{i-1,j})|+|L(P_{i,j+2})−L(P_{i,j})|+|L(P_{i+1,j+2})−L(P_{i+1,j})|+|L(P_{i-1,j-2})−L(P_{i-1,j})|+|L(P_{i,j-2})−L(P_{i,j})|+|L(P_{i+1,j-2})−L(P_{i+1,j})|.

According to the Bayer pattern, pixels P_{i-1,j+2}, P_{i-1,j} and P_{i-1,j-2} have the same color; pixels P_{i,j+2}, P_{i,j} and P_{i,j-2} have the same color; and pixels P_{i+1,j+2}, P_{i+1,j} and P_{i+1,j-2} have the same color. Therefore, the vertical edge variation V is calculated based on luminance gradients of the same color. It should be noted that another color filter array may be used instead of the Bayer color filter array described herein.

Similar to the vertical edge variation V, the horizontal edge variation H of the pixel P_{i,j} at (i,j) is obtained from the following formula:

$$H = {\sum }_{n = - a}^{+ a} \vert L ( {P}_{i + 2 , j + n} ) - L ( {P}_{i , j + n} ) \vert + {\sum }_{n = - a}^{+ a} \vert L ( {P}_{i - 2 , j + n} ) - L ( {P}_{i , j + n} ) \vert .$$

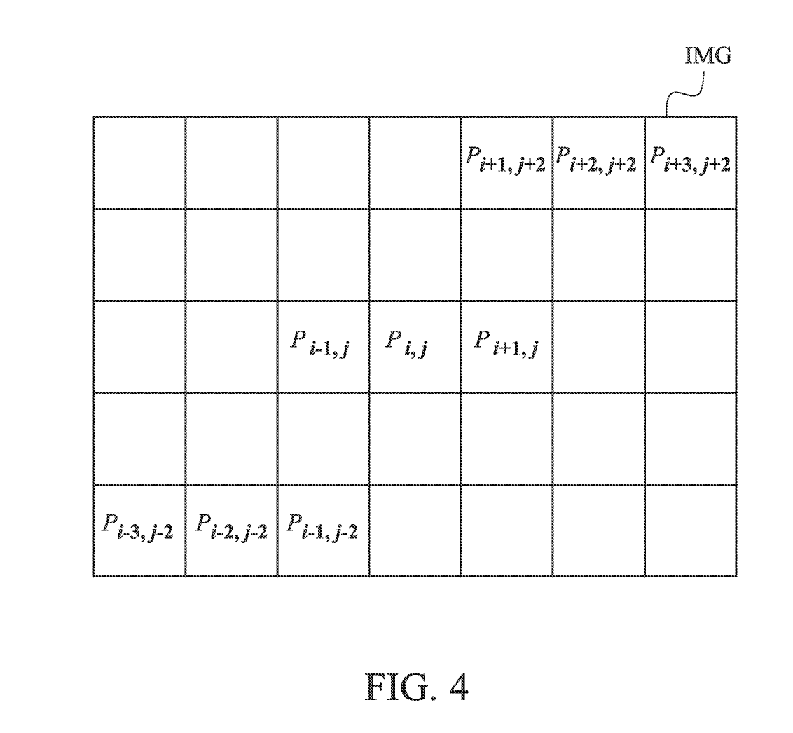

FIG. 4 illustrates an example of computing a first diagonal edge variation. The first diagonal edge variation D1 of the pixel P_{i,j} at (i,j) is obtained from the following formula:

$$D 1 = {\sum }_{n = - a}^{+ a} \vert L ( {P}_{i + n + 2 , j + 2} ) - L ( {P}_{i + n , j} ) \vert + {\sum }_{n = - a}^{+ a} \vert L ( {P}_{i + n - 2 , j - 2} ) - L ( {P}_{i + n , j} ) \vert .$$

Based on the formula described above, take a=1 as an example, as shown in FIG. 4, the first diagonal edge variation D1 of the pixel P_{i,j} at (i,j) is:

D1=|L(P_{i+1,j+2})−L(P_{i-1,j})|+|L(P_{i+2,j+2})−L(P_{i,j})|+|L(P_{i+3,j+2})−L(P_{i+1,j})|+|L(P_{i-3,j-2})−L(P_{i-1,j})|+|L(P_{i-2,j-2})−L(P_{i,j})|+|L(P_{i-1,j-2})−L(P_{i+1,j})|.

According to the Bayer pattern, pixels P_{i+i,j+2}, P_{i-1,j} and P_{i-3,j-2} have the same color; pixels P_{i+2,j+2}, P_{i,j} and P_{i-2,j-2} have the same color; and pixels P_{i+3,j+2}, P_{i+i,j} and P_{i-1,j-2} have the same color. Therefore, the first diagonal edge variation D1 is calculated based on luminance gradients of the same color.

Similar to the first diagonal edge variation D1, the second diagonal edge variation D2 of the pixel P_{i,j} at (i,j) is obtained from the following formula:

$$D 2 = {\sum }_{n = - a}^{+ a} \vert L ( {P}_{i + n - 2 , j + 2} ) - L ( {P}_{i + n , j} ) \vert + {\sum }_{n = - a}^{+ a} \vert L ( {P}_{i + n + 2 , j - 2} ) - L ( {P}_{i + n , j} ) \vert .$$

As described above, after step S201, each pixel has the vertical edge variation V, the horizontal edge variation H, the first diagonal edge variation D1 and the second diagonal edge variation D2. To be noted, although the user-defined positive integers in formulas of the vertical edge variation V, the horizontal edge variation H, the first diagonal edge variation D1 and the second diagonal edge variation D2 are all indicated as a, in practical four formulas can use different values of user-defined positive integers.

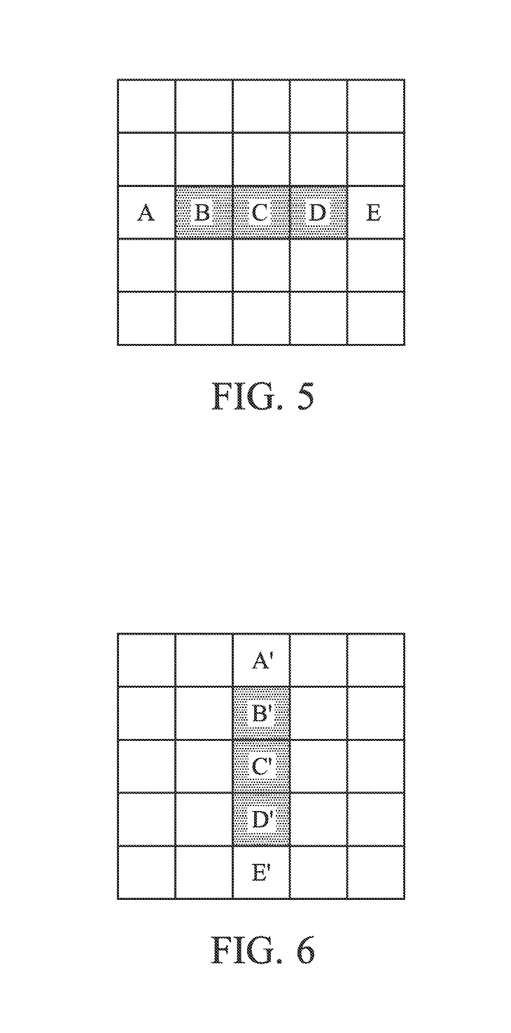

FIG. 5 illustrates an example of computing a highly vertical level. To compute a highly vertical level HVL of a pixel C, first a mask is used to select a group of pixels that contain the pixel C. The mask can be any shape. In FIG. 5, the mask is a rectangular shape with a 3-pixel width and a 1-pixel height. Therefore, the selected group contains pixels B, C and D. Each pixel of the selected group has a weighting. In one example, all weightings of pixels of the selected group are 1. In another example, a weighting of a center pixel of a selected pixels is 1, and the farther a pixel is away from the center pixel, the smaller a weighting thereof is.

In one example, the highly vertical level HVL is determined according to the following codes:

cnt0, cnt1=0;
if (L_{A}>L_{B} &L_{C}>L_{B}) cnt1= cnt1+W_{B};
if (L_{B}<L_{C} & L_{D}<L_{C}) cnt1= cnt1+W_{C};
if (L_{C}>L_{D} & L_{E}>L_{D}) cnt1= cnt1+W_{D};
if (L_{A}<L_{B} & L_{C}<L_{B}) cnt0= cnt0+W_{B};
if (L_{B}>L_{C} & L_{D}>L_{C}) cnt0= cnt0+W_{C};
if (L_{C}<L_{D} & L_{E}<L_{D}) cnt0= cnt0+W_{D}; and
return max(cnt0, cnt1),
wherein L_{X} is luminance of a pixel X, and W_{X} is a weighting of the
pixel X.

As described above, the highly vertical level HVL of the pixel C represents the possibility that the pixel C is in a region where luminance values of pixels fluctuate in a horizontal direction. There are two situations that the pixel C is in the region where luminance values of pixels fluctuate in a horizontal direction. The first situation is that the trend of the luminance of the pixels from the pixel A to the pixel E is high-low-high-low-high. The second situation is that the trend of the luminance of the pixels from the pixel A to the pixel E is low-high-low-high-low. The parameter cnt1 represents the first situation while the parameter cnt0 represents the second situation. If ctn0 is larger than cnt1, the highly vertical level HVL of the pixel C is ctn0, which means the pixel C is more possible in the second situation than in the first situation.

The condition “L_{A}>L_{B}” in the above codes is true when luminance of the pixel A is larger than luminance of the pixel B. In another example, the condition “L_{A}>L_{B}” can be designed to be true when luminance of the pixel A and luminance of the pixel B are both larger than a pre-determined threshold and luminance of the pixel A is larger than luminance of the pixel B.

Similarly, FIG. 6 illustrates an example of computing a highly horizontal level. To compute a highly horizontal level HHL of a pixel C′, first a mask is used to select a group of pixels that contain the pixel C′. The mask can be any shape. In FIG. 6, the mask is a rectangular shape with a 1-pixel width and a 3-pixel height. Therefore, the selected group contains pixels B′, C′ and D′. Each pixel of the selected group has a weighting. In one example, all weightings of pixels of the selected group are 1. In another example, a weighting of a center pixel of selected pixels is 1, and the farther a pixel is away from the center pixel, the smaller a weighting thereof is.

In one example, the highly horizontal level HHL is determined according to the following codes:

cnt0’, cnt1’=0;
if (L_{A’}>L_{B’} &L_{C’}>L_{B’}) cnt1’= cnt1+W_{B’};
if (L_{B’}<L_{C’} & L_{D’}<L_{C’}) cnt1’= cnt1’+W_{C’};
if (L_{C’}>L_{D’} & L_{E’}>L_{D’}) cnt1’= cnt1’+W_{D’};
if (L_{A’}<L_{B’} & L_{C’}<L_{B’}) cnt0’= cnt0’+W_{B’};
if (L_{B’}>L_{C’} & L_{D’}>L_{C’}) cnt0’= cnt0’+W_{C’};
if (L_{C'}<L_{D’} & L_{E’}<L_{D’}) cnt0’= cnt0’+W_{D’}; and
return max(cnt0’, cnt1’),
wherein L_{X’} is luminance of a pixel X’, and W_{X’} is a weighting of the
pixel X’.

As described above, the highly horizontal level HHL of the pixel C′ represents the possibility that the pixel C′ is in a region where luminance values of pixels fluctuate in a vertical direction. There are two situations that the pixel C′ is in the region where luminance values of pixels fluctuate in a vertical direction. The first situation is that the trend of the luminance of the pixels from the pixel A′ to the pixel E′ is high-low-high-low-high. The second situation is that the trend of the luminance of the pixels from the pixel A′ to the pixel E′ is low-high-low-high-low. The parameter cnt1′ represents the first situation while the parameter cnt0′ represents the second situation. If ctn0′ is larger than cnt1′, the highly horizontal level HHL of the pixel C′ is ctn0′, which means the pixel C is more possible in the second situation than in the first situation.

As described above, since the highly vertical level HVL and the highly horizontal level HHL are calculated based on luminance of the pixels which are not necessarily the same color, using the highly vertical level HVL and the highly horizontal level HHL to decide the interpolating direction can improve performance especially when information of the same color is not enough, such as for one-pixel-wide stripes in the image.

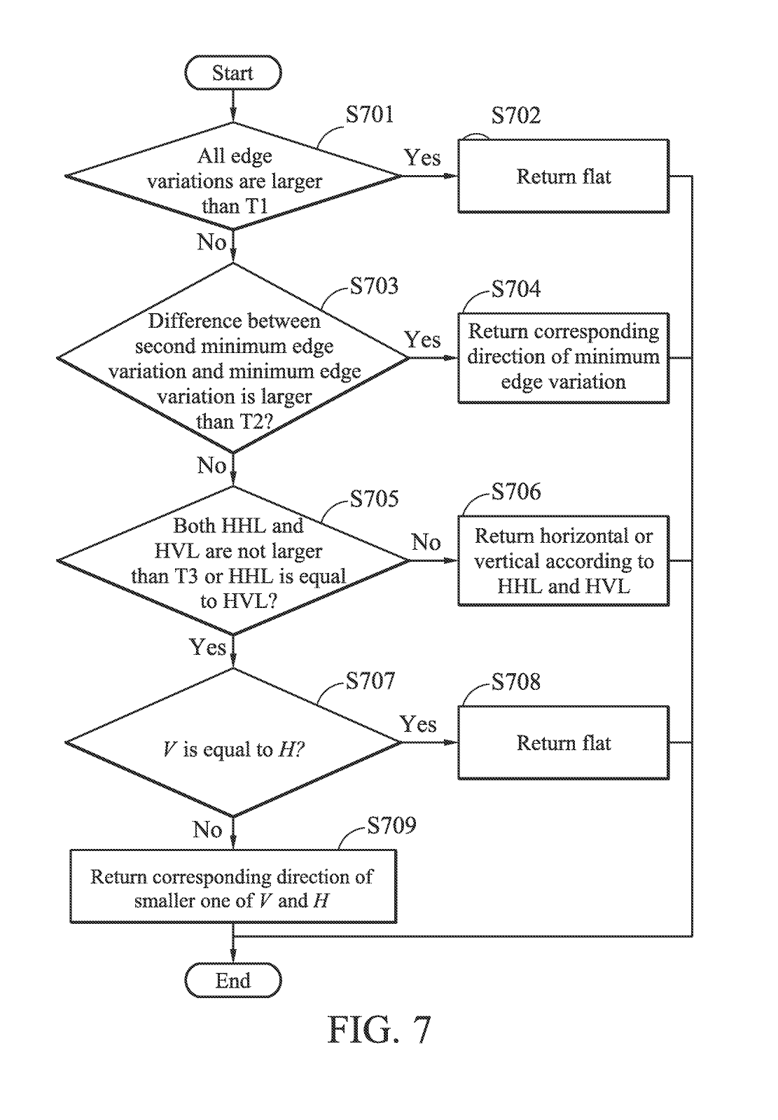

After step S202, the highly vertical level HVL and the highly horizontal level HHL of each pixel is obtained. Then an interpolating direction of each pixel is determined based on edge information V, H, D1 and D2, the highly vertical level HVL and the highly horizontal level HHL in step S203, as shown in FIG. 7.

FIG. 7 illustrates a flow chart of determining an interpolating direction of each pixel in accordance with an embodiment of the invention.

If all edge information, that is, edge variations V, H, D1 and D2, are larger than a first predetermined threshold T1 (step S701: Yes), the interpolating direction of the pixel is not obvious, then the interpolating direction of the pixel is flat (step S702). In color demosaicking, “flat” means no particular interpolating direction is used when interpolating. If all edge variations V, H, D1 and D2 of a pixel are large, the pixel might be in a region with complicated texture. Therefore, the interpolating direction of the pixel is flat. If not all the edge variations V, H, D1 and D2 are larger than the first predetermined threshold T1 (step S701: No), then whether the difference between the second minimum edge variation and the minimum edge variation is larger than a second predetermined threshold T2 is checked (step S703). If the difference between the second minimum edge variation and the minimum edge variation is larger than the second predetermined threshold T2 (step S703: Yes), the interpolating direction is a corresponding direction of corresponding luminance gradient of the minimum edge variation. If the difference between the second minimum edge variation and the minimum edge variation is larger than the second predetermined threshold T2, the minimum edge variation is significantly smaller than the other edge variations. Therefore, the change of luminance in the corresponding direction of the minimum edge variation is much smoother than in the other directions, and interpolating information of the other two colors along the corresponding direction of the minimum edge variation may avoid interpolating across an edge on which the pixel might lie. For example, if H is the second minimum edge variation, V is the minimum edge variation and the difference between H and V, that is, (H−V), is larger than T2, the interpolating direction of the pixel is vertical.

If the difference between the second minimum edge variation and the minimum edge variation is not larger than the second predetermined threshold T2 (step S703: No), then two conditions are checked to determine whether the interpolating direction is to be determined according to the highly horizontal level HHL and the highly vertical level HVL or not (step S705). The first condition is that both the highly horizontal level HHL and the highly vertical level HVL are not larger than a third predetermined threshold T3, and the second condition is that the highly horizontal level HHL is equal to the highly vertical level HVL. If both conditions are not met (step S705: No), the interpolating direction is determined according to the highly horizontal level HHL and the highly vertical level HVL (Step S706). For example, if HHL is larger than T3 and HVL is smaller than T3, the two conditions are both not met. In this example, since HHL is larger, the interpolating direction is horizontal. If one of the conditions is met (step S705: Yes), the interpolating direction is determined not according to the highly horizontal level HHL and the highly vertical level HVL but according to the vertical edge variation V and the horizontal edge variation H, as shown in steps S707˜S709.

If one of the two conditions is met (step S705: Yes), then whether the vertical edge variation V is equal to the horizontal edge variation H is checked (S707). If the vertical edge variation V is equal to the horizontal edge variation H (step S707: Yes), the interpolating direction is flat (step S708). If the vertical edge variation V is not equal to the horizontal edge variation H (step S707: No), the interpolating direction is a direction of a luminance gradient of the smaller one of the vertical edge variation V and the horizontal edge variation H (step S709). For example, in step S709, if the horizontal edge variation H is smaller than the vertical edge variation V, the interpolating direction is horizontal. All the thresholds T1, T2 and T3 may be determined based on sharpness measurements and human vision. Frequency response of a standard test image may be considered when determining the thresholds. For example, some image analyzing software, such as imatest and ImageJ, may be utilized to decide the thresholds.

The interpolating direction of each pixel determined by steps in FIG. 7 is used to interpolate information of missing two colors along the interpolating direction. For example, if an interpolating direction of a pixel is vertical, information of missing two colors of the pixel can be obtained from information of neighboring pixels thereabove and neighboring pixels therebelow. The interpolating direction of each pixel determined by steps in FIG. 7 can be used by any known interpolating method, such as bilinear interpolation.

In another embodiment of determining an interpolating direction of each pixel, first the vertical edge variation V and the horizontal edge variation H are modified respectively as following:

$${V}^{′} = \frac{1}{HVL} \times V ;$$

$$and$$

$${H}^{′} = \frac{1}{HHL} \times H .$$

The highly vertical level HVL and the highly horizontal level HHL are used as weightings to modify the vertical edge variation V and the horizontal edge variation H. Then the interpolating direction is a direction of a luminance gradient of the smaller one of the modified vertical edge variation V′ and the modified horizontal edge variation H′. For example, if the modified horizontal edge variation H′ is smaller than the modified vertical edge variation V′, the interpolating direction is horizontal.

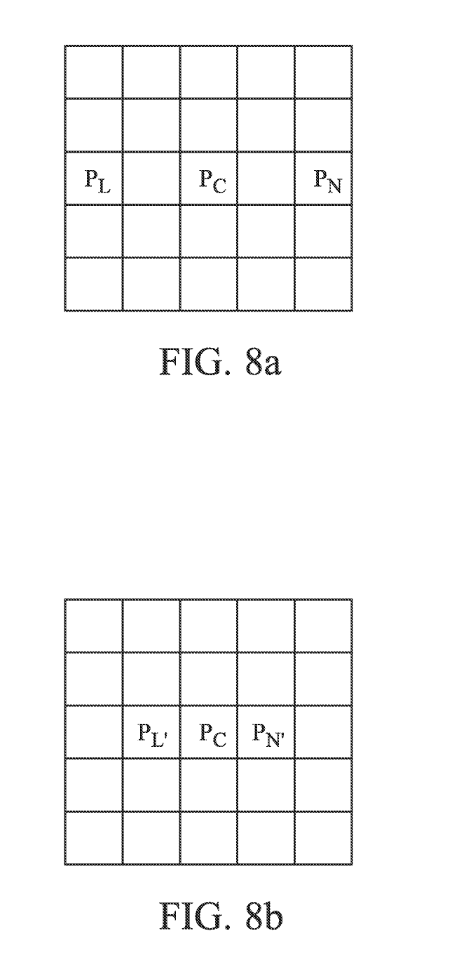

In another embodiment, after determining interpolating directions of all pixels, the consistency of the interpolating directions is checked. FIG. 8a and FIG. 8b illustrate examples of checking the consistency of the interpolating directions. FIG. 8a illustrates an example of checking the consistency of a pixel P_{C} and its neighboring pixels P_{L} and P_{N}, wherein pixels P_{C}, P_{L} and P_{N} are in the same color in a Bayer pattern. If the interpolating direction of the pixel P_{C} is horizontal or vertical, one of pixels P_{L} and P_{N} is checked to see if it has the same interpolating direction as the pixel P_{C}. If one of the pixels P_{L} and P_{N} has the same interpolating direction as the pixel P_{C}, the interpolating direction of the pixel P_{C} is trustworthy, and the interpolating direction of the pixel P_{C} can't be changed when implementing color demosaicking on the pixel P_{C}. If none of the pixels P_{L} and P_{N} has the same interpolating direction as the pixel P_{C}, the interpolating direction of the pixel P_{C} can be changed by a built-in method for determining interpolating direction of a color demosaicking method.

FIG. 8b illustrates an example of checking the consistency of the pixel P_{C} and its neighboring pixels P_{L′} and P_{N′}, wherein pixels P_{C}, P_{L′} and P_{N′}; are not in the same color in a Bayer pattern. If the interpolating direction of the pixel P_{C} is horizontal or vertical, whether one of pixels P_{L′} and P_{N′} has the same interpolating direction as the pixel P_{C} is checked. If one of pixels P_{L′} and P_{N′} has the same interpolating direction as the pixel P_{C}, the interpolating direction of the pixel P_{C} is trustworthy, and the interpolating direction of the pixel P_{C} can't be changed when implementing color demosaicking on the pixel P_{C}. If none of pixels P_{L′} and P_{N′} has the same interpolating direction as the pixel P_{C}, the interpolating direction of the pixel P_{C} can be changed by a built-in method for determining interpolating direction of a color demosaicking method.

The method for determining interpolating direction for color demosaicking described above may take the form of a program code (i.e., instructions) embodied on a non-transitory machine-readable storage medium such as floppy diskettes, CD-ROMS, hard drives, firmware, or any other machine-readable storage medium. When the program code is loaded into and executed by a machine, such as a digital imaging device or a computer, the machine implements the method for determining interpolating direction for color demosaicking.

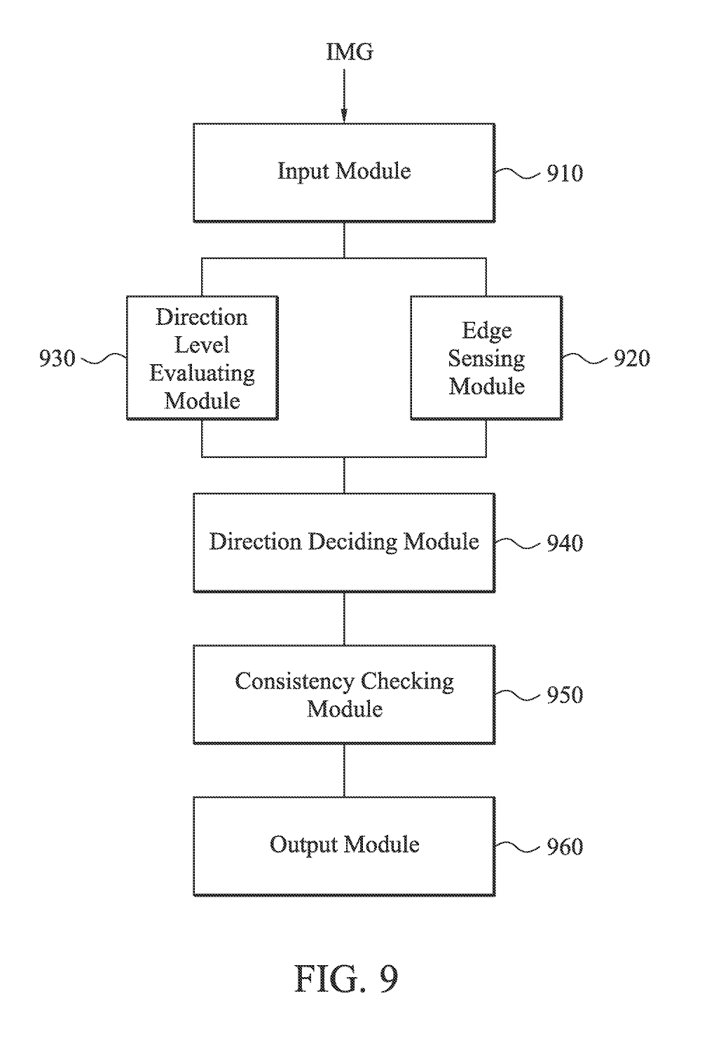

FIG. 9 illustrates a block diagram of an apparatus 90 for determining interpolating direction for color demosaicking in accordance with an embodiment of the invention.

The apparatus 90 comprises an input module 910, an edge sensing module 920, a direction level evaluating module 930, a direction determining module 940, a consistency checking module 950 and an output module 960. All modules may be general-purpose processors. The input module 910 receives an image IMG captured by a color filter array, such as a Bayer color filter array. The edge sensing module 920 is coupled to the input module and obtains edge information of each pixel of the image as described in step S201 of FIG. 2. The direction level evaluating module 930 is coupled to the input module 910 and determines a highly horizontal level HHL and a highly vertical level HVL of each pixel as described in step S202 of FIG. 2. The direction determining module 940 is coupled to the edge sensing module 920 and the direction level evaluating module 930. The direction determining module 940 implements steps of FIG. 7 to decide an interpolating direction of each pixel based on the edge information obtained from the edge sensing module 920 and the highly horizontal level HHL and the highly vertical level HVL determined by the direction level evaluating module 930. The consistency checking module 950 is coupled to the direction determining module 940 and checks the consistency between the interpolating direction of each pixel and interpolating directions of its neighbor pixels as described in FIG. 8a and FIG. 8b. The output module 960 is coupled to the consistency checking module 950 and outputs the interpolating direction of each pixel. The interpolating direction of each pixel outputted by the output module 960 is used to interpolate information of missing two colors for each pixel.

Methods and apparatuses of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for determining interpolating direction for color demosaicking, comprising:
obtaining edge information of each pixel of an image captured by a color filter array;
determining a highly horizontal level and a highly vertical level of each pixel; and
determining an interpolating direction of each pixel based on the edge information, the highly horizontal level and the highly vertical level of the pixel.

2. The method as claimed in claim 1, further comprising:
checking the consistency between the interpolating direction of each pixel and interpolating directions of neighboring pixels.

3. The method as claimed in claim 2, wherein the edge information comprises:
a vertical edge variation, representing a vertical luminance gradient of the pixel;
a horizontal edge variation, representing a horizontal luminance gradient of the pixel;
a first diagonal edge variation, representing a northeast-southwest luminance gradient of the pixel; and
a second diagonal edge variation, representing a northwest-southeast luminance gradient of the pixel.

4. The method as claimed in claim 3, wherein the color filter array is a Bayer color filter.

5. The method as claimed in claim 4, wherein the vertical edge variation V, the horizontal edge variation H, the first diagonal edge variation D1 and the second diagonal edge variation D2 of each pixel P_{i,j} are respectively obtained from formulas:
$$V = {\sum }_{n = - a}^{+ a} \vert L ( {P}_{i + n , j + 2} ) - L ( {P}_{i + n , j} ) \vert + {\sum }_{n = - a}^{+ a} \vert L ( {P}_{i + n , j - 2} ) - L ( {P}_{i + n , j} ) \vert ;$$
$$H = {\sum }_{n = - a}^{+ a} \vert L ( {P}_{i + 2 , j + n} ) - L ( {P}_{i , j + n} ) \vert + {\sum }_{n = - a}^{+ a} \vert L ( {P}_{i - 2 , j + n} ) - L ( {P}_{i , j + n} ) \vert ;$$
$$D 1 = {\sum }_{n = - a}^{+ a} \vert L ( {P}_{i + n + 2 , j + 2} ) - L ( {P}_{i + n , j} ) \vert + {\sum }_{n = - a}^{+ a} \vert L ( {P}_{i + n - 2 , j - 2} ) - L ( {P}_{i + n , j} ) \vert ;$$
$$and$$
$$D 2 = {\sum }_{n = - a}^{+ a} \vert L ( {P}_{i + n - 2 , j + 2} ) - L ( {P}_{i + n , j} ) \vert + {\sum }_{n = - a}^{+ a} \vert L ( {P}_{i + n + 2 , j - 2} ) - L ( {P}_{i + n , j} ) \vert ,$$
wherein a is a positive integer and L(P_{x, y}) is luminance of a pixel P_{x, y}.

6. The method as claimed in claim 3, wherein the step of determining the highly horizontal level of each pixel P_{i,j} comprises:
selecting a first group of pixels which contains the pixel P_{i,j};
forming a plurality of first sets, wherein each pixel P_{r, s} of the first group is a center pixel of one of the plurality of first sets, and each first set includes pixels P_{r, s-1}, P_{r, s} and P_{r, s+1}; and
checking each first set, which comprises:
if luminance of the pixel P_{r, s} is smaller than luminance of the pixel P_{r, s-1} and luminance of the pixel P_{r, s+1}, adding a weighting of the pixel P_{r, s} to a first highly horizontal level; and
if luminance of the pixel P_{r, s} is larger than luminance of the pixel P_{r, s-1} and luminance of the pixel P_{r, s+1}, adding the weighting of the pixel P_{r, s} to a second highly horizontal level,
wherein the highly horizontal level of the pixel P_{i,j} is equal to a maximum one of the first highly horizontal level and the second highly horizontal level.

7. The method as claimed in claim 6, wherein the step of determining the highly vertical level of each pixel P_{i,j} comprises:
selecting a second group of pixels which contain the pixel P_{i,j};
forming a plurality of second sets, wherein each pixel P_{r, s} of the second group is a center pixel of one of the plurality of second sets, and each second set includes pixels P_{r-1, s}, P_{r, s} and P_{r+1, s}; and
checking each second set, which comprises:
if luminance of the pixel P_{r, s} is smaller than luminance of P_{r-1, s} and luminance of the pixel P_{r+1, s}, adding the weighting of the pixel P_{r, s} to a first highly vertical level; and
if luminance of the pixel P_{r, s} is larger than luminance of the pixel P_{r-1, s} and luminance of the pixel P_{r+1, s}, adding the weighting of the pixel P_{r, s} to a second highly vertical level,
wherein the highly vertical level of the pixel P_{i,j} is equal to a maximum one of the first highly vertical level and the second highly vertical level.

8. The method as claimed in claim 7, wherein the weighting of the weighting of the pixel P_{r, s} is 1.

9. The method as claimed in claim 5, wherein the step of determining the interpolating direction further comprises:
if all edge variations of the edge information are larger than a first predetermined threshold, the interpolating direction is flat;
if the difference between the second minimum edge variation and the minimum edge variation is larger than a second predetermined threshold, the interpolating direction is a direction of a luminance gradient of the minimum edge variation;
if both the highly horizontal level and the highly vertical level are not larger than a third predetermined threshold, or if the highly horizontal level is equal the highly vertical level, the interpolating direction is a direction of a luminance gradient of smaller one of the vertical edge variation and the horizontal edge variation when the vertical edge variation is not equal to the horizontal edge variation or flat when the vertical edge variation is equal to the horizontal edge; and
else the interpolating direction is a corresponding direction of the larger one of the highly horizontal level and the highly vertical level.

10. A non-transitory machine-readable storage medium, having an encoded program code, wherein when the program code is loaded into and executed by a machine, the machine implements a method for determining interpolating direction for color demosaicking, and the method comprises:
obtaining edge information of each pixel of an image captured by a color filter array;
determining a highly horizontal level and a highly vertical level of each pixel; and
determining an interpolating direction of each pixel based on the edge information, the highly horizontal level and the highly vertical level of the pixel.

11. The non-transitory machine-readable storage medium as claimed in claim 10, wherein the method further comprises:
checking the consistency between the interpolating direction of each pixel and interpolating directions of neighboring pixels.

12. The non-transitory machine-readable storage medium as claimed in claim 11, wherein the edge information comprises:
a vertical edge variation, representing a vertical luminance gradient of the pixel;
a horizontal edge variation, representing a horizontal luminance gradient of the pixel;
a first diagonal edge variation, representing a northeast-southwest luminance gradient of the pixel; and
a second diagonal edge variation, representing a northwest-southeast luminance gradient of the pixel.

13. The non-transitory machine-readable storage medium as claimed in claim 12, wherein the color filter array is a Bayer color filter.

14. The non-transitory machine-readable storage medium as claimed in claim 13, wherein the vertical edge variation V, the horizontal edge variation H, the first diagonal edge variation D1 and the second diagonal edge variation D2 of a pixel at (i, j) are respectively obtained from formulas:
$$V = {\sum }_{n = - a}^{+ a} \vert L ( i + n , j + 2 ) - L ( i + n , j ) \vert + {\sum }_{n = - a}^{+ a} \vert L ( i + n , j - 2 ) - L ( i + n , j ) \vert ;$$
$$H = {\sum }_{n = - a}^{+ a} \vert L ( i + 2 , j + n ) - L ( i , j + n ) \vert + {\sum }_{n = - a}^{+ a} \vert L ( i - 2 , j + n ) - L ( i , j = n ) \vert ;$$
$$D 1 = {\sum }_{n = - a}^{+ a} \vert L ( i + n + 2 , j + 2 ) - L ( i + n , j ) \vert + {\sum }_{n = - a}^{+ a} \vert L ( i + n - 2 , j - 2 ) - L ( i + n , j ) \vert ;$$
$$D 2 = {\sum }_{n = - a}^{+ a} \vert L ( i + n - 2 , j + 2 ) - L ( i + n , j ) \vert + {\sum }_{n = - a}^{+ a} \vert L ( i + n + 2 , j - 2 ) - L ( i + n , j ) \vert$$
wherein a is a positive integer and L(x, y) is luminance of a pixel at (x,y).

15. The non-transitory machine-readable storage medium as claimed in claim 12, wherein the step of determining the highly horizontal level of each pixel P_{i, j} comprises:
selecting a first group of pixels which contains the pixel P_{i,j};
forming a plurality of first sets, wherein each pixel P_{r, s} of the first group is a center pixel of one of the plurality of first sets, and each first set includes pixels P_{r, s-1}, P_{r, s} and P_{r, s+1}; and
checking each first set, which comprises:
if luminance of the pixel P_{r, s} is smaller than luminance of the pixel P_{r, s-1} and luminance of the pixel P_{r, s+1}, adding a weighting of the pixel P_{r, s} to a first highly horizontal level; and
if luminance of the pixel P_{r, s} is larger than luminance of the pixel P_{r, s-1} and luminance of the pixel P_{r, s+1}, adding the weighting of the pixel P_{r, s} to a second highly horizontal level,
wherein the highly horizontal level of the pixel P_{i,j} is equal to a maximum one of the first highly horizontal level and the second highly horizontal level.

16. The non-transitory machine-readable storage medium as claimed in claim 15, wherein the step of determining the highly vertical level of each pixel P_{i, j} comprises:
selecting a second group of pixels which contains the pixel P_{i,j};
forming a plurality of second sets, wherein each pixel P_{r, s} of the second group is a center pixel of one of the plurality of second sets, and each second set includes pixels P_{r-1, s}, P_{r, s} and P_{r+1, s}; and
checking each second set, which comprises:
if luminance of the pixel P_{r, s} is smaller than luminance of P_{r-1, s} and luminance of the pixel P_{r+1, s}, adding the weighting of the pixel P_{r, s} to a first highly vertical level; and
if luminance of the pixel P_{r, s} is larger than luminance of the pixel P_{r-1, s} and luminance of the pixel P_{r+1, s}, adding the weighting of the pixel P_{r, s} to a second highly vertical level,
wherein the highly vertical level of the pixel P_{i,j} is equal to a maximum one of the first highly vertical level and the second highly vertical level.

17. The non-transitory machine-readable storage medium as claimed in claim 16, wherein the weighting of the pixel P_{r, s} is 1.

18. The non-transitory machine-readable storage medium as claimed in claim 14, wherein the step of determining the interpolating direction further comprises:
if all edge variations of the edge information are larger than a first predetermined threshold, the interpolating direction is flat;
if the difference between the second minimum edge variation and the minimum edge variation is larger than a second predetermined threshold, the interpolating direction is a direction of a luminance gradient of the minimum edge variation;
if both the highly horizontal level and the highly vertical level are not larger than a third predetermined threshold, or if the highly horizontal level is equal the highly vertical level, the interpolating direction is a direction of a luminance gradient of smaller one of the vertical edge variation and the horizontal edge variation when the vertical edge variation is not equal to the horizontal edge variation or flat when the vertical edge variation is equal to the horizontal edge; and
else the interpolating direction is a corresponding direction of the larger one of the highly horizontal level and the highly vertical level.

19. An apparatus for determining interpolating direction for color demosaicking, comprising:
an input module, receiving an image captured by a color filter array;
an edge sensing module coupled to the input module, obtaining edge information of each pixel of the image;
a direction level evaluating module coupled to the input module, determining a highly horizontal level and a highly vertical level of each pixel;
a direction determining module coupled to the edge sensing module and the direction level evaluating module, determining an interpolating direction of each pixel based on the edge information, the highly horizontal level and the highly vertical level of the pixel; and
an output module coupled to the direction determining module, outputting the interpolating direction of each pixel.

20. The apparatus as claimed in claim 19 further comprises:
a consistency checking module coupled between the direction determining module and the output module, checking the consistency between the interpolating direction of each pixel and interpolating directions of neighbor pixels.
